(19) United States
(12) Patent Application Publication
(10) Pub. No.: US 2026/0086221 A1
(43) Pub. Date: Mar. 26, 2026

(54) FRAME OF REFERENCE COORDINATION BETWEEN WIRELESS DEVICES

(71) Applicant: QUALCOMM Incorporated, San Diego, CA (US)

(72) Inventors: Himaja KESAVAREDDIGARI, Bridgewater, NJ (US); Hong CHENG, Basking Ridge, NJ (US); Kapil GULATI, Belle Mead, NJ (US); Dan VASSILOVSKI, Del Mar, CA (US); Gene Wesley MARSH, San Diego, CA (US); Shijun WU, San Diego, CA (US)

(21) Appl. No.: 18/895,310

(22) Filed: Sep. 24, 2024

(51) Int. Cl. G01S 13/58; G01S 5/04; G01S 13/42; H04L 5/00

(52) U.S. Cl. CPC G01S 13/58; G01S 5/04; G01S 13/42; H04L 5/0048

(57) ABSTRACT

Techniques for coordinating a frame of reference between wireless devices may comprise determining a displacement vector of a wireless mobile device with respect to its local coordinate system, the displacement vector indicative of a displacement of the wireless mobile device between a first time and a second time. Techniques may further comprise the wireless mobile device receiving, from a first wireless reference device, an indication of a displacement vector of the wireless mobile device with respect to a common reference direction, and adjusting an estimated alignment of the common reference direction with respect to the wireless mobile device's local coordinate system, based at least in part on correction information determined from a comparison of (i) the displacement vector of the wireless mobile device with respect to its local coordinate system with (ii) the displacement vector of the wireless mobile device with respect to the common reference direction.

### BACKGROUND

### 1. Field of Disclosure

The present disclosure relates generally to the field of wireless communications and, more specifically, to radio frequency (RF)-based positioning.

### 2. Description of Related Art

Many wireless mobile devices can perform positioning, such as global navigation satellite system (GNSS)-based positioning, to determine an estimate of their location. This can provide significant added value to users. Mobile phones and vehicles, for example, can use such positioning to provide location-based services, such as maps and navigation. Further, determining the position of a mobile phone or vehicle can help emergency services quickly locate people in need. GNSS and other types of RF-based positioning may use an earth-centered, earth-fixed (ECEF) coordinate system. However, knowledge of this coordinate system may not always be available to a wireless mobile device.

### BRIEF SUMMARY

An example method of coordinating a frame of reference between wireless devices, according to this disclosure, comprises determining, at a wireless mobile device, a displacement vector of the wireless mobile device with respect to a local coordinate system of the wireless mobile device. The displacement vector indicates a set of one or more attributes of displacement from a location of the wireless mobile device at a first time to a location of the wireless mobile device at a second time. The method may further comprise receiving, at the wireless mobile device from a first wireless reference device, an indication of a displacement vector of the wireless mobile device with respect to a common reference direction. The method may further comprise adjusting, at the wireless mobile device, an estimated alignment of the common reference direction with respect to the local coordinate system of the wireless mobile device. The adjusting may be based at least in part on correction information determined from a comparison of (i) the displacement vector of the wireless mobile device with respect to the local coordinate system of the wireless mobile device with (ii) the displacement vector of the wireless mobile device with respect to the common reference direction.

An example wireless mobile device, according to this disclosure, comprises at least one transceiver, at least one memory, and at least one processor communicatively coupled with the at least one transceiver and at least one memory. The at least one processor is configured to determine a displacement vector of the wireless mobile device with respect to a local coordinate system of the wireless mobile device, the displacement vector indicating a set of one or more attributes of displacement from a location of the wireless mobile device at a first time to a location of the wireless mobile device at a second time. The at least one processor also may be configured to receive, via the at least one transceiver from a first wireless reference device, an indication of a displacement vector of the wireless mobile device with respect to a common reference direction. The at least one processor also may be configured adjust an estimated alignment of the common reference direction with respect to the local coordinate system of the wireless mobile device. The adjusting may be based at least in part on correction information determined from a comparison of: (i) the displacement vector of the wireless mobile device with respect to the local coordinate system of the wireless mobile device with (ii) the displacement vector of the wireless mobile device with respect to the common reference direction.

An example device, according to this disclosure, comprises means for determining a displacement vector of a wireless mobile device with respect to a local coordinate system of the wireless mobile device, the displacement vector indicating a set of one or more attributes of displacement from a location of the wireless mobile device at a first time to a location of the wireless mobile device at a second time. The device further may comprise means for receiving, from a first wireless reference device, an indication of a displacement vector of the wireless mobile device with respect to a common reference direction. The device further may comprise means for adjusting an estimated alignment of the common reference direction with respect to the local coordinate system of the wireless mobile device. The adjusting may be based at least in part on correction information determined from a comparison of: (i) the displacement vector of the wireless mobile device with respect to the local coordinate system of the wireless mobile device with (ii) the displacement vector of the wireless mobile device with respect to the common reference direction.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning system, according to an embodiment.

FIG. 2 is a simplified diagram of a global navigation satellite system (GNSS) system 200, according to an embodiment.

FIGS. 3A-3D are a series of diagrams illustrating an example of how a reference device can provide alignment information to a separate mobile device, according to some embodiments.

FIGS. 4A-4D are a series of diagrams illustrating another example of how a reference device can provide alignment information to a separate mobile device, according to some embodiments.

FIG. 5 is a message flow diagram of an example process by which a wireless reference device may provide a wireless mobile device with alignment assistance, according to an embodiment.

FIG. 6 is a message flow diagram of another example process by which a wireless reference device may provide a wireless mobile device with alignment assistance, according to an embodiment.

FIG. 7 is a flow diagram of a method of coordinating a frame of reference between wireless devices, according to an embodiment.

FIG. 8 is a flow diagram of another method of coordinating a frame of reference between wireless devices, according to an embodiment.

FIG. 9 is a block diagram of an embodiment of a wireless device.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3, etc., or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples in which one or more aspects of the disclosure may be implemented are described below, other examples may be used, and various modifications may be made without departing from the scope of the disclosure or the spirit of the appended claims.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The following description is directed to certain implementations for the purposes of describing innovative aspects of various embodiments. However, a person having ordinary skill in the art will readily recognize that the teachings herein can be applied in a multitude of different ways. The described implementations may be implemented in a device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

As used herein, the terms “mobile device” and “User Equipment” (UE) may be used interchangeably and are not intended to be specific or otherwise limited to any particular Radio Access Technology (RAT), unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or other electronic device that may be used for Global Navigation Satellite Systems (GNSS) positioning as described herein. According to some embodiments, a mobile device and/or UE may be used to communicate over a wireless communications network. A UE may be mobile or may (e.g., at certain times) be stationary, and may communicate with a Radio Access Network (RAN). As used herein, the term UE may be referred to interchangeably as an Access Terminal (AT), a client device, a wireless device, a subscriber device, a subscriber terminal, a subscriber station, a user terminal (UT), a mobile device, a mobile terminal, a mobile station, or variations thereof. Generally, UEs can communicate with a core network via a RAN, and through the core network, the UEs can be connected with external networks (such as the Internet) and with other UEs. Other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 standard, etc.), and so on.

A “space vehicle” (SV) as referred to herein, relates to an object that is capable of transmitting signals to receivers on the earth's surface. In one particular example, such a SV may comprise a geostationary satellite. Alternatively, a SV may comprise a satellite traveling in an orbit and moving relative to a stationary position on the earth. However, these are merely examples of SVs and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video and/or data I/O devices and/or body sensors and a separate wireline or wireless modem. As described herein, an estimate of a location of the Global Positioning System (GPS) receiver may be referred to as a location, location estimate, location fix, fix, position, position estimate or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another. Additional discussion of coordinate frames as provided below. It can be noted that “coordinate frame,” “coordinate system,”“frame of reference,”and the like are used interchangeably.

As noted, many wireless mobile devices can perform positioning, such as global navigation satellite system (GNSS)-based positioning, to determine an estimate of their location. Positioning information obtained by wireless mobile devices, such as measurements performed by the devices, is often obtained in a frame of reference local to each device, which may be referred to herein as a local coordinate system. When communicating such information from one device to another, the information therefore may need to be transformed to a common frame of reference, such as an earth-centered, earth-fixed (ECEF) coordinate system, in order to be understood by the receiving device. However, estimation of a device's local coordinate system with respect to a common frame of reference may encounter challenges due to biases and errors in positioning data. Therefore, accurate estimates of a device's local coordinate system with respect to a common frame of reference may also offer corrections to biases and errors in positioning data. GNSS and other types of positioning provide ways in which a device may obtain an accurate estimate of its local coordinate system with respect to a common frame of reference (e.g., ECEF). However, positioning information may be unavailable to a device in certain conditions, such as when positioning signals (e.g., GNSS signals) are occluded, when positioning is turned off by the device, etc. In such conditions, without such positioning, devices may often fail to have an accurate estimate of a common frame of reference.

Embodiments described herein address these and other issues by providing techniques in which a reference device having an accurate estimate of a common frame of reference (e.g., a device with reliable GNSS service and/or other positioning) can provide alignment information to a mobile device without an accurate estimate of the common frame of reference, enabling the mobile device to improve the accuracy of the estimation of the common frame of reference (e.g., with respect to its local coordinate system) over time. Various aspects relate generally to the field of RF-based positioning of a mobile devices, and in particular, mobile devices capable of communicating with each other and having positioning capabilities. Some aspects more specifically relate to techniques, which may be iterative in nature, in which a reference device and a mobile device in line of sight (LOS) conditions may perform angle and ranging measurements and share estimates of the common frame of reference in order to produce correction information that can be used by the mobile device to improve its estimate of the common frame of reference. These techniques may be triggered by a variety of conditions, including the loss of GNSS coverage and/or other type of positioning resources by the mobile device, and may further utilize multiple reference devices in a process that can involve the handing off of tasks performed by a first reference device to a second reference device. It can be noted that, although embodiments described herein often use GNSS positioning as a way in which a common frame of reference may be found, embodiments may use additional or alternative types of positioning.

Particular aspects of the subject matter described in this disclosure can be implemented to realize one or more of the following potential advantages. In some examples, by providing techniques in which a mobile device may increase the accuracy of its estimate of a common frame of reference, embodiments may enable increased accuracy in positioning of mobile devices due to the mitigation of errors and biases in positioning data that may result when positioning data is transformed to a common frame of reference. Moreover, because these techniques may be performed in locations in which a mobile device may not otherwise be able to determine an accurate estimate of the common frame of reference, embodiments can help reduce areas in which and/or periods of time during in which positioning these and other advantages will be apparent to persons of ordinary skill in light of the disclosed embodiments detailed hereafter. A discussion of embodiments is provided after a brief discussion of relevant technology and context/background in which embodiments may be used.

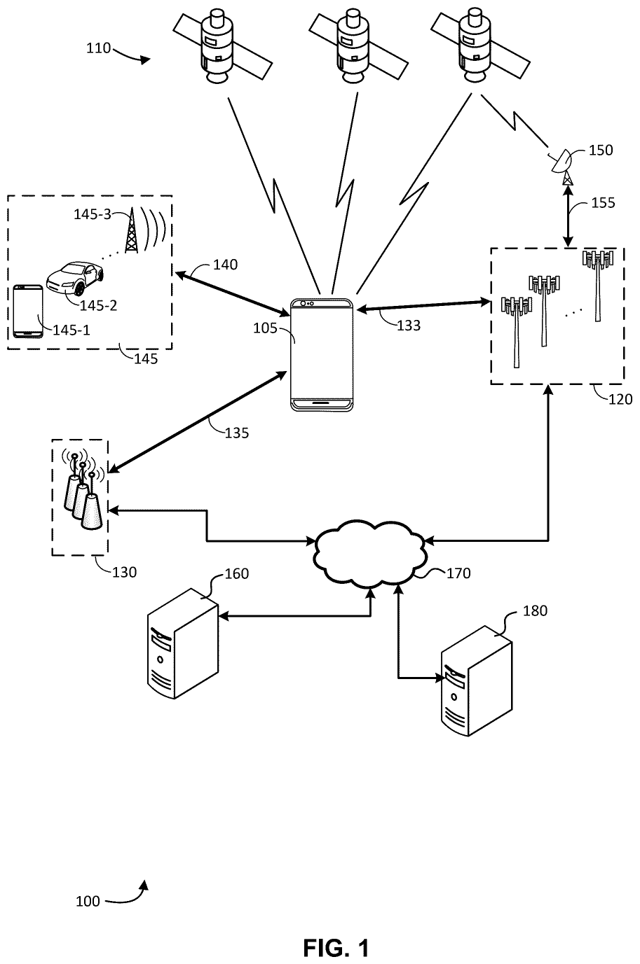

FIG. 1 is a simplified illustration of a positioning system 100 in which a mobile device 105, location server 160, and/or other components of the positioning system 100 can use the techniques provided herein for frame of reference coordination between GNSS and non-GNSS users, according to an embodiment. The techniques described herein may be implemented by one or more components of the positioning system 100, however, the techniques described herein are not limited to such components and may be implemented in other types of systems (not shown). The positioning system 100 can include: a mobile device 105; one or more satellites 110 (also referred to as space vehicles (SVs)) for a GNSS such as the GPS, GLONASS (GLO), Galileo (GAL), or BeiDou Navigation Satellite System (BDS) over China; base stations 120; access points (APs) 130; location server 160; network 170; and external client 180. Generally put, the positioning system 100 can estimate the location of the mobile device 105 based on radio frequency (RF) signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other non-terrestrial network (NTN) platforms, which may be implemented on aircraft, balloons, etc.) can be utilized to perform positioning (e.g., of one or more wireless devices) and/or perform RF sensing (e.g., of one or more objects by using RF signals transmitted by one or more wireless devices).

In this example, FIG. 1 illustrates the mobile device 105 as a smartphone device, however, mobile devices may be any suitable device that includes GNSS capabilities or may be a device or machine into which such GNSS capabilities are integrated. Thus, a mobile device 105 may include personal devices such as a smartphone, smartwatch, tablet, laptop, etc. However, mobile devices may include a larger class of device as well and may include vehicles with integrated GNSS receivers and positioning systems, such as boats or ships, cars, trucks, aircraft, shipping containers, etc. As noted, in certain contexts, such as in reference to a cellular network, the mobile device 105 may be referred to as a UE.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). In an LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” used herein may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As noted, satellites 110 may be used to implement NTN functionality, extending communication, positioning, and potentially other functionality (e.g., RF sensing) of a terrestrial network. As such, one or more satellites may be communicatively linked to one or more NTN gateways 150 (also known as “gateways,” “earth stations,” or “ground stations”). The NTN gateways 150 may be communicatively linked with base stations 120 via link 155. In some embodiments, NTN gateways 150 may function as DUs of a base station 120, as described previously. Not only can this enable the mobile device 105 to communicate with the network 170 via satellites 110, but this can also enable network-based positioning, RF sensing, etc.

Satellites 110 may be utilized in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance (range) and/or angle measurements, along with known position of the one or more components. As described herein, the term “ranging” measurements between two devices may refer to measurements (made by one or both devices) of RF signals exchanged between the devices to determine a range (distance) between devices. Measurements may be coordinated by devices participating in the exchange of RF signals and/or the network.

The location server 160 may support positioning of the mobile device 105 using a CP location solution when mobile device 105 accesses the network 170 (e.g., a cellular or WLAN network) and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The location server 160 may also process location service requests for the mobile device 105, e.g., received from an external client 180 and/or a function within the network 170.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra-Wideband (UWB), IEEE 802.15x, or a combination thereof. Mobile devices 145 may additionally or alternatively use non-RF wireless signals for positioning of the mobile device 105, such as infrared signals or other optical technologies.

Mobile devices 145 may comprise other UEs communicatively coupled with a cellular or other mobile network (e.g., network 170). When one or more other mobile devices 145 comprising UEs are used in the position determination of a particular mobile device 105, the mobile device 105 for which the position is to be determined may be referred to as the “target mobile device,” and each of the one or more other mobile devices 145 used may be referred to as an “anchor mobile device.” For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond with a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate,” “estimated location,” “location,” “position,” “position estimate,” “position fix,” “estimated position,” “location fix” or “fix.” The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

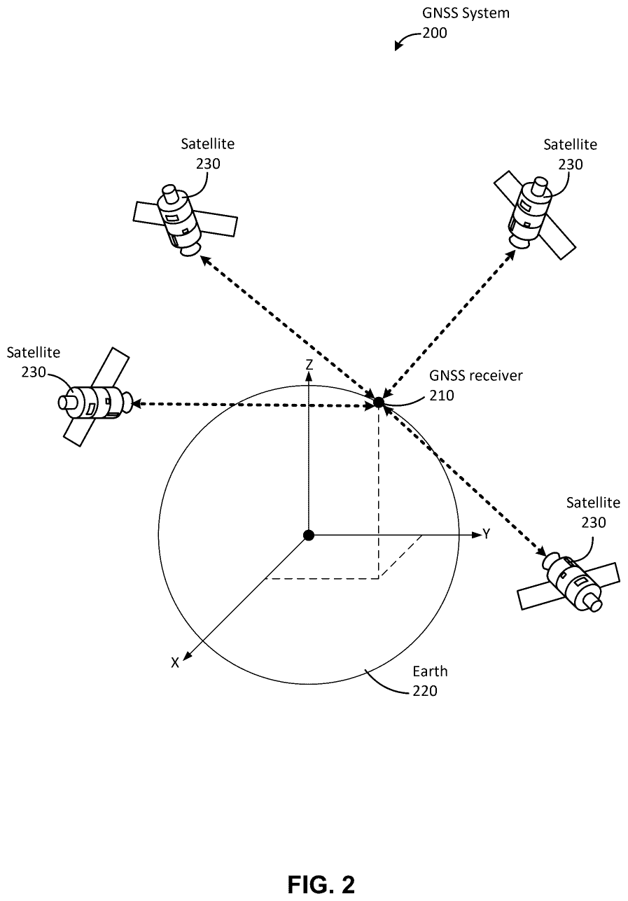

As noted, the mobile device 105 of FIG. 1 may be capable of GNSS positioning. Details regarding GNSS positioning of a mobile device 105, or any device comprising a GNSS receiver, are provided hereafter with regard to FIG. 2.

FIG. 2 is a simplified diagram of a GNSS system 200, provided to illustrate how GNSS is generally used to determine an accurate location of a GNSS receiver 210 on earth 220. Put generally, the GNSS system 200 enables an accurate GNSS position fix of the GNSS receiver 210, which receives RF signals from GNSS satellites 230 from one or more GNSS constellations. The types of GNSS receiver 210 used may vary, depending on application. In some embodiments, for instance, the GNSS receiver 210 may comprise a standalone device or component incorporated into another device (e.g., mobile device 105 of FIG. 1). In some embodiments, the GNSS receiver 210 may be integrated into industrial or commercial equipment, such as survey equipment, Internet of Things (IoT) devices, etc.

It will be understood that the diagram provided in FIG. 2 is greatly simplified. In practice, there may be dozens of satellites 230 and a given GNSS constellation, and there are many different types of GNSS systems. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, the determination of the position of a GNSS receiver 210 in three dimensions may rely on a determination of the distance between the GNSS receiver 210 and four or more satellites 230. As illustrated, 3D coordinates may be based on a coordinate system (e.g., XYZ coordinates; latitude, longitude, and altitude; etc.) centered at the earth's center of mass. (A commonly used coordinate system centered at the Earth's center of mass is the earth-centered, earth-fixed (ECEF) coordinate frame, in which the positive X axis passes through the Equator and Prime Meridian intersection, the positive Z axis passes through the North Pole, and the Y axis is orthogonal to X and Z axes.) A distance between each satellite 230 and the GNSS receiver 210 may be determined using precise measurements made by the GNSS receiver 210 of a difference in time from when an RF signal is transmitted from the respective satellite 230 to when it is received at the GNSS receiver 210. To help ensure accuracy, not only does the GNSS receiver 210 need to make an accurate determination of when the respective signal from each satellite 230 is received, but many additional factors need to be considered and accounted for. These factors include, for example, clock differences at the GNSS receiver 210 and satellite 230 (e.g., clock bias), a precise location of each satellite 230 at the time of transmission (e.g., as determined by the broadcast ephemeris), the impact of atmospheric distortion (e.g., ionospheric and tropospheric delays), and the like.

To perform a traditional GNSS position fix, the GNSS receiver 210 can use code-based positioning to determine its distance to each satellite 230 based on a determined delay in a generated pseudorandom binary sequence received in the RF signals received from each satellite, in consideration of the additional factors and error sources previously noted. With the distance and location information of the satellites 230, the GNSS receiver 210 can then determine a position fix for its location. This position fix may be determined, for example, by a Standalone Positioning Engine (SPE) executed by one or more processors of the GNSS receiver 210. However, code-based positioning is relatively inaccurate and, without error correction, and is subject to many of the previously described errors. Even so, code-based GNSS positioning can provide an positioning accuracy for the GNSS receiver 210 on the order of meters.

More accurate carrier-based ranging is based on a carrier wave of the RF signals received from each satellite, and may use measurements at a base or reference station (not shown) to perform error correction to help reduce errors from the previously noted error sources. More specifically, errors (e.g., atmospheric errors sources) in the carrier-based ranging of satellites 230 observed by the GNSS receiver 210 can be mitigated or canceled based on similar carrier-based ranging of the satellites 230 using a highly accurate GNSS receiver at the base station at a known location. These measurements and the base station's location can be provided to the GNSS receiver 210 for error correction. This position fix may be determined, for example, by a Precise Positioning Engine (PPE) executed by one or more processors of the GNSS receiver 210. More specifically, in addition to the information provided to an SPE, the PPE may use base station GNSS measurement information, and additional correction information, such as troposphere and ionosphere, to provide a high accuracy, carrier-based position fix. Several GNSS techniques can be adopted in PPE, such as Differential GNSS (DGNSS), Real Time Kinematic (RTK), and Precise Point Positioning (PPP), and may provide a sub-meter accuracy (e.g., on the order of centimeters). (An SPE and/or PPE may be referred to herein as a GNSS positioning engine, and may be incorporated into a broader positioning engine that uses other (non-GNSS) positioning sources.)

As previously noted, GNSS and other positioning may utilize global coordinate systems, such as ECEF, to communicate location, measurements, and other types of positioning information. Having a common frame of reference is particularly useful when two wireless devices (e.g., two GNSS devices) communicate such positioning information to each other. Processing positioning information from multiple wireless devices (e.g., fusing data from different devices) often may require that the two wireless devices transform their data to a common reference frame. The transformation of data from a local coordinates system of a wireless device to a global or common coordinate system is often referred to as “registration.” Registration can be particularly challenging in cases where one or both wireless devices comprise mobile devices (e.g., cell phones) that may be subject to abrupt and/or frequent changes in orientation.

Ongoing GNSS positioning of mobile devices can help mitigate challenges in registration. That is, a mobile device that knows its location with respect to a global coordinate system may be less prone to severe systematic errors and/or biases in measured data, prior to registering it to the global coordinate system. However, due to occlusions of GNSS signals (e.g., when a mobile device is in an “urban canyon,”), a mobile device may lose GNSS functionality. This can result in an increasingly poor estimate by the mobile device of its orientation relative to a global coordinate system (e.g., due to sensor drift and/or other errors). Thus, positioning information communicated by the mobile device may be more prone to reflect the systematic errors and/or biases that GNSS positioning otherwise helps mitigate.

To help address these and other issues, embodiments herein provide for the communication of data to a mobile device to help the mobile device more accurately estimate its alignment (e.g., the alignment of a local coordinate system of the mobile device) to a global coordinate system. For simplicity, embodiments herein will discuss this alignment estimation as an estimation of (the direction) north, although this may extend to an estimate of any direction or global/common coordinate system. As such, the phrase or notion of “determining the alignment to ECEF coordinate system” may be used interchangeably with “estimating north,”“estimating true north,”and similar phrases.

A technological problem addressed by embodiments discussed herein may be described as follows. For a global ECEF frame of reference denoted as G, the local frame of reference of the GNSS antenna of a base station B, and the local frame of reference of the GNSS antenna of an i-th UE as Fᵢ, how can an entity such as B or F₁ (having a knowledge of the global coordinate system G, e.g., due to having GNSS coverage) communicate the global coordinate system to another entity F₂ (with no knowledge of its alignment with G, e.g., no GNSS coverage)? Variations to this problem can consider (i) how the use of inertial information can be used to estimate transformations between G, B, and any Fᵢ, (ii) how transformations between G and any two or more Fᵢ can be estimated in an open sky environment with the use of inertial/vision information, and/or (iii) how transformations between G and any two or more Fᵢ can be estimated in an urban canyon environment with the use of inertial/vision information. Moreover, embodiments for communicating alignment of the global coordinate system with respect to entity F₂ described herein can be used in a variety of cases, such as when the reference device providing the alignment information (e.g., F₁) has a high-accuracy estimate of its alignment with respect to the global coordinate system G and a line of sight (LoS) to entity F₂. Entity F₂, on the other hand, may not have an accurate estimate of its alignment with respect to global coordinate system G due to various issues such as (i) no access to GNSS and no prior knowledge of its alignment with respect to global coordinate system G, (ii) being located in an urban canyon with access to GNSS, but with a low-accuracy estimation of its alignment to global coordinate system G, (iii) having had previous access to GNSS with a high accuracy estimation of its alignment to global coordinate system G, but conserving power by switching off positioning services (such as GNSS). In any of these cases and particularly in this latter case, entity F₂, also may be a handheld wireless device with frequent changes in orientation. Additionally, as described in more detail below, use cases may cover the situation in which the reference device providing the alignment information (e.g., F₁) has lost or anticipates losing a line of sight (LoS) to entity F₂, in which case the task of providing alignment information to the entity F₂ may be handed over to another reference device (e.g., F₃).

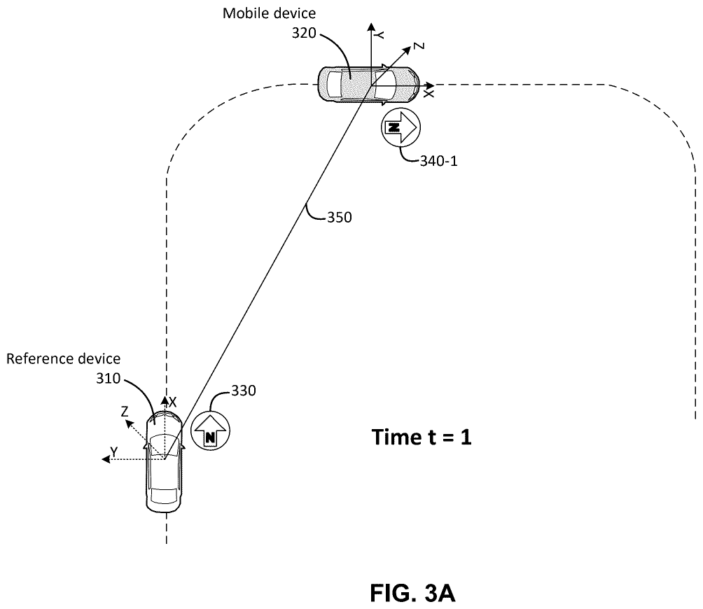

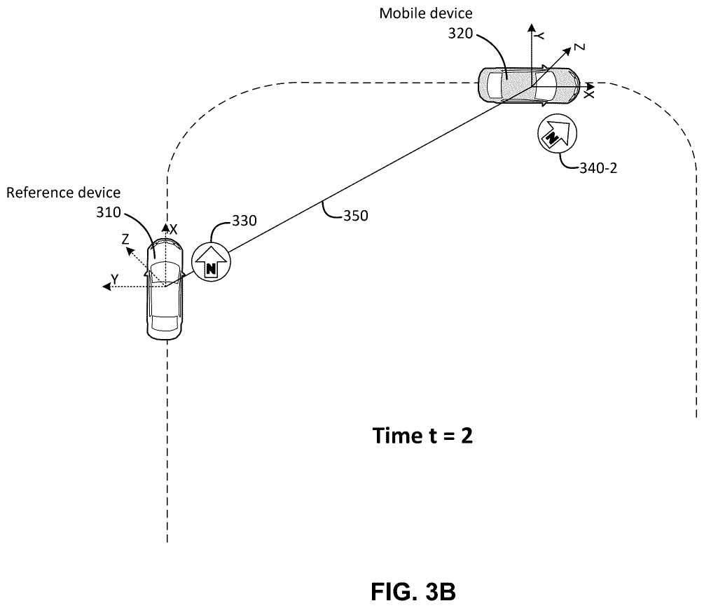

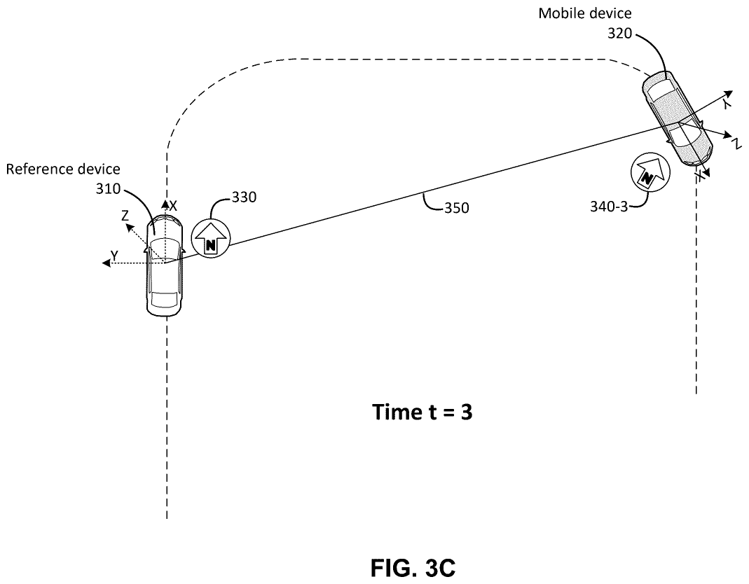

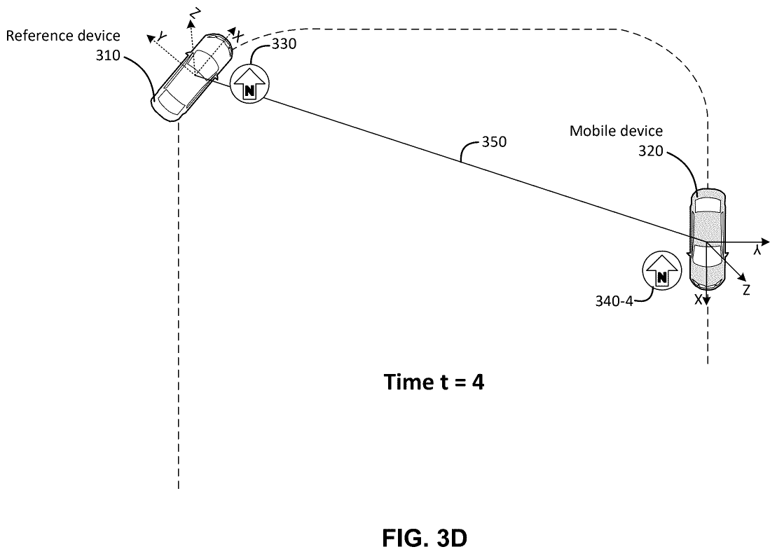

FIGS. 3A-3D are a series of diagrams illustrating an example of how a reference device 310 (also referred to herein as a “wireless reference device” in view of its wireless capabilities), can provide alignment information to a separate mobile device 320 to enable the mobile device 320 to determine its alignment with respect to a common reference frame (e.g., ECEF), according to some embodiments. In FIGS. 3A-3D, estimated alignments by the reference device 310 and the mobile device 320 with the common reference frame are respectively shown as estimates of north 330 and 340 (the latter of which varies with time and is labeled with time dependency sequentially as 340-1, 340-2, 340-3, and 340-4). The reference device 310 may have access to GNSS and/or other positioning information that enables it to have an accurate estimate 330 of north. This estimate 330 is considered a “steady state” estimate, used to assist the mobile device 320 in correcting its estimate 340 of north (considered an “evolving” or “ongoing” estimate). Although illustrated as vehicles embodiments are not so limited. The reference device 310 and mobile device 320 may comprise any of a variety of different types of GNSS devices, UEs, or other wireless electronic devices. Further, the triggering of the iterative process illustrated in FIGS. 3A-3D may be based on the detection of an initiation condition, and may be stopped based on the detection of a termination condition. Example initiation and termination conditions are provided below.

The process of providing alignment information illustrated in FIGS. 3A-3D comprises an iterative process in which, for each time t=n, the mobile entity 320 and/or reference entity 310 conduct RF-based ranging and angular (e.g., AOA and/or AOD) measurements (represented by line 350), and the mobile entity 320 provides the reference entity 310 with its local frame of reference, its estimate 340 of north, and its relative displacement in its local frame of reference from a previous time (t=n−1). (For an initial time, t=1, displacement information may not be available.) The reference entity 310 can then compare the ongoing estimate 340 and direction of displacement (e.g., displacement vector) provided by the mobile entity 320 in the mobile entity's local coordinates system with the displacement of the mobile entity 320 perceived by the reference entity 310 relative to the reference entity's local coordinate system or steady state estimate 330 to determine correction information for the mobile entity 320, which it may then send to the mobile entity 320. In determining the correction information, the reference entity 310 can also account for any movement (displacement and/or rotation) made by the reference entity 310 from the previous time (t=n−1). This process can be repeated at subsequent times (n=1, 2, 3, 4, etc.), and the intervals between/periodicity of times (e.g., every 0.25, 0.5, 1, 2, 3, 5, or 10 seconds, etc.) may be determined by the reference entity 310 and/or mobile entity 320, according to some embodiments.

FIG. 3A, which illustrates the reference device 310 and mobile device 320 at an initial state at the beginning of the process of providing alignment information, where time t=1. As illustrated, the ongoing estimate 340-1 of the mobile device 320 is inaccurate, approximately 90° clockwise of the reference device's accurate, steady-state estimate 330 of north.

FIG. 3B illustrates a second time (time t=2), during which, as noted above, angle and ranging measurements may be taken (line 350). The mobile entity 320 may communicate its displacement (e.g., based on current and previous angle and ranging measurements) and ongoing estimate to the reference entity 310. The reference entity 310 may determine correction information, accounting for its own displacement from time t=1 to time t=2. It may then send to the correction information to the mobile entity 320, which may update its ongoing estimate accordingly. As shown in FIG. 3B, the updated ongoing estimate 340-2 is more accurate than the ongoing estimate 340-1 at the previous time, due to the application of correction information received from the reference entity 310.

Further iterations result in increased accuracy in the ongoing estimate 340. FIG. 3C illustrates a third time (time t=3), during which the process described above iterates yet again, resulting in a more accurate ongoing estimate 340-3. FIG. 3D illustrates a fourth time (time t=4), during which the process described above iterates yet again, resulting in an even more accurate ongoing estimate 340-4. Further iterations may be conducted, or the process may be concluded, based on whether a termination condition is met.

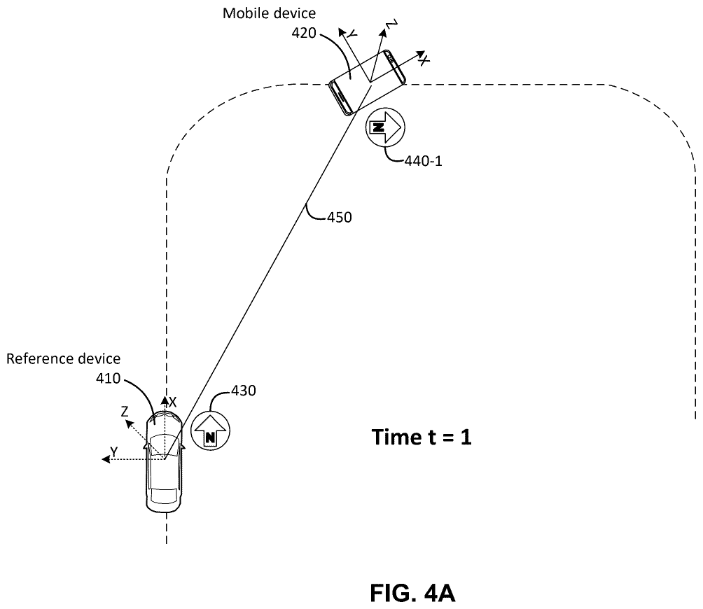

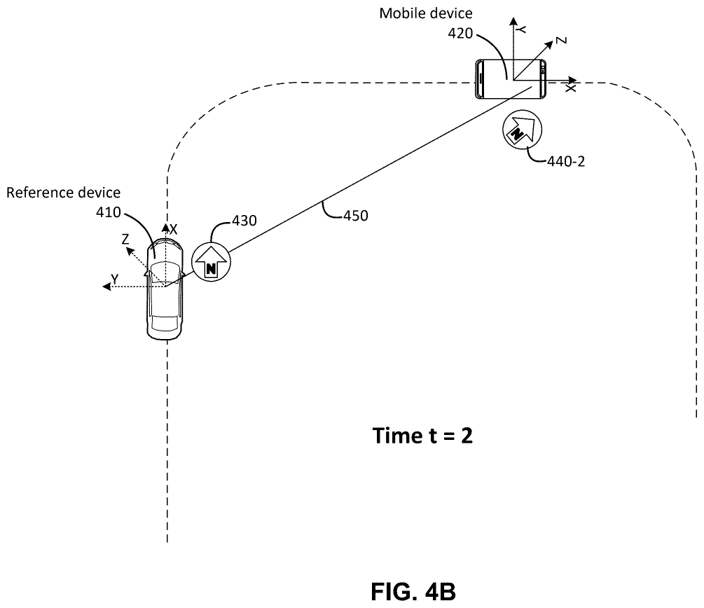

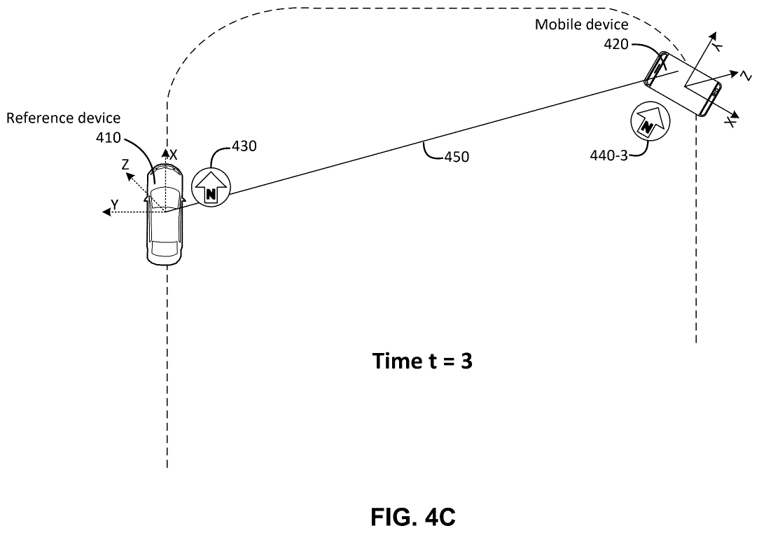

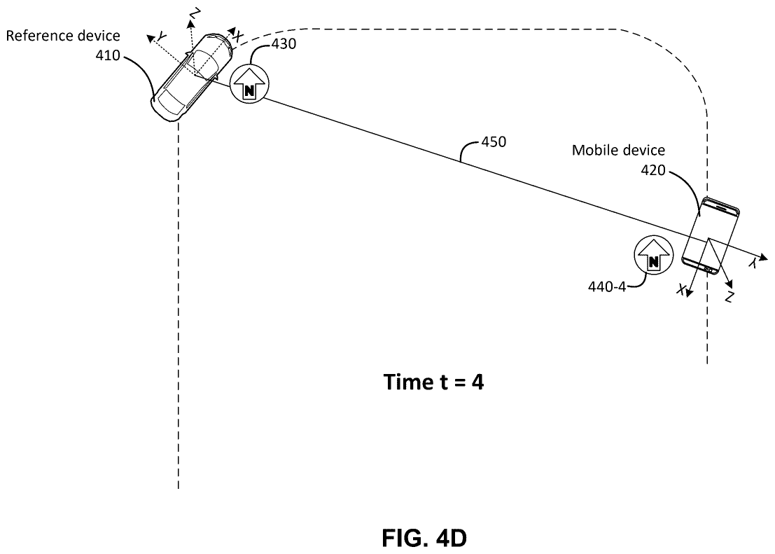

FIGS. 4A-4D are a series of diagrams illustrating another example of how a reference device 410, can provide alignment information to a separate mobile device 420 to enable the mobile device 420 to determine its alignment with respect to a common reference frame (e.g., ECEF), according to some embodiments. FIGS. 4A-4D generally echo FIGS. 3A-3D, and features of FIGS. 4A-4D labeled 410-450 may correspond with counterpart features of FIGS. 3A-3D labeled 310-350 described above. In FIGS. 4A-4D, however, the mobile device 420 comprises a mobile phone that is subject to more changes in orientation than the vehicular mobile device 320 of FIGS. 3A-3D. As such, changes in the mobile device 420 may be accounted for (e.g., using an accelerometer, gyroscope, internal measurement unit (IMU), etc.) when determining the ongoing estimate 440 and applying correction information from the reference device 410. For example, if the mobile device 420 provides the reference device 410 with an estimate 440-1 of north relative to the local coordinate system of the mobile device 420 at time t=1, correction information provided by the reference device 410 may be with respect to the local coordinate system of the mobile device 420 at time t=1. Thus, when receiving and applying the correction information at sometime after time t=1, the mobile device 420 may account for changes in its orientation since time t=1.

As noted previously, the iterative process providing alignment information from a reference device to a separate mobile device to enable the mobile device to determine its alignment with respect to a common reference frame may initiate upon the detection of an initiation condition and terminate upon the detection of a termination condition. An initiation condition may comprise any condition in which the mobile device may not be aligned with a common reference frame, as detected by the mobile device, reference device, and/or other device or function. Initiation conditions may include, for example, the mobile device and/or reference device determining that the mobile device has lost GNSS positioning (and/or another type of positioning), the mobile device has no estimate of north, the mobile device's estimate of north is stale (i.e., time elapsed since most recent alignment between local coordinate system and ECEF exceeds threshold), the mobile device's estimate of north is no longer within a threshold degree of accuracy (which may be determined based on known information regarding sensor drift and/or other factors upon which the estimate of north is made), the mobile device has switched off a GNSS positioning (and/or another type of positioning) service, the mobile device was dedicating lesser resources to a GNSS positioning (and/or another type of positioning) service to tradeoff power consumption against precision, the mobile device is entered into a region associated with low-accuracy GNSS performance, or the like. Additionally, as described in more detail below, the task of providing alignment information to a mobile device may be “handed off” from one reference device to another (e.g., when the reference device and/or mobile device has lost or expects to lose LOS conditions with the mobile device (e.g., within a threshold length of time)), in which case an initiation condition for initiating providing alignment information to a mobile device by a first reference device may comprise receiving handoff information at the reference device from the mobile device and/or a second reference device. According to some embodiments, an initiation condition may comprise any combination of the conditions described in this paragraph.

Termination conditions may comprise any condition in which the mobile device may no longer need alignment with a common reference frame, as detected by the mobile device, reference device, and/or other device or function, and may generally mirror the initiation conditions described above. Termination conditions may include, for example, the mobile device and/or reference device determining that the mobile device has regained GNSS positioning (and/or another type of positioning), the mobile device's estimate of north is within a threshold degree of accuracy, the mobile device has switched on a GNSS positioning (and/or another type of positioning) service, the mobile device has exited a region associated with low-accuracy GNSS performance, or the like. With respect to the handover between reference devices previously noted, a termination condition may comprise, for example, a determination by the reference device and/or mobile device that LOS conditions between the reference device and the mobile device have been lost or are expected to be lost (e.g., within a threshold length of time). According to some embodiments, a termination condition may comprise any combination of the conditions described in this paragraph.

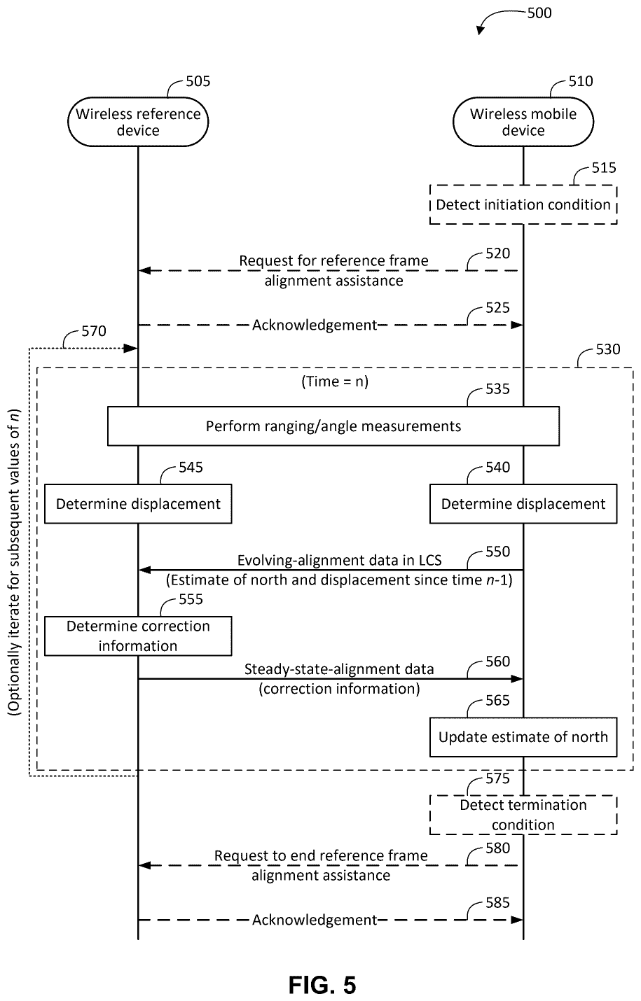

FIG. 5 is a message flow diagram of an example process 500 by which a wireless reference device 505 may provide a wireless mobile device 510 with alignment assistance to help increase the accuracy of an estimate of a common reference direction (e.g., north) the wireless mobile device 510. It can be noted that, although specified as “wireless” in FIG. 5, the wireless reference device 505 and wireless mobile device 510 may respectively correspond with a reference device and mobile device as described in the embodiments above. Aspects of the process 500 may correspond with the iterative process described above and illustrated in FIGS. 3A-3D and 4A-4D. Optional functionality is illustrated with dashed or dotted lines. Communication between wireless reference device 505 and wireless mobile device 510 may be conducted via wireless device-to-device (D2D) communications such as sidelink, for example. As with other figures, FIG. 5 is provided as a non-limiting example, and a person of ordinary skill in the art will appreciate how alternative embodiments may vary from the functionality illustrated in FIG. 5.

The process 500 may begin with the functionality at block 515, in which the wireless mobile device 510 optionally detecting an initiation condition. Again, the initiation condition may be any of the various initiation conditions described above. And, in alternative embodiments, an initiation condition may be detected by the wireless reference device 505. Responsive to detecting the initiation condition at block 515, the wireless mobile device 510 may then send a request for ECEF alignment assistance, as shown by arrow 520, to which the wireless reference device 505 may send an acknowledgment, as indicated by arrow 525. According to some embodiments, some additional information may be exchanged in and/or accompanying the request and/or acknowledgment, such as capability information related to the process 500 (e.g., capabilities regarding RF-based ranging and/or angle measurements, accuracy of reference direction estimation, etc.), verification that LOS and/or other conditions are in place for the process 500 to proceed, or the like.

The operations encompassed in block 530 may then be performed, which may reflect at least some of the aspects of the iterative process described in previous embodiments. This includes the functionality at block 535, during which the wireless reference device 505 and/or wireless mobile device 510 perform RF-based ranging and angle measurements, as described previously. According to some embodiments, ranging measurements can include RTT measurements and angle measurements can include AOA and/or AOD measurements, for example. At block 540 and 545, the wireless mobile device 510 and wireless reference device 505 may then determine displacement of the wireless mobile device 510 since a previous time (e.g., n−1), which may be based at least in part on the ranging/angle measurements performed at block 535. Additionally, if the wireless reference device 505 has moved since the previous time, the wireless reference device 505 may determine its own placement (which, as noted, may be accounted for when determining the correction information). The wireless mobile device 510 may then provide evolving alignment data. As previously mentioned, this information may include the wireless mobile device's estimate of north and its own displacement, in the local coordinate system of the wireless mobile device 510. At block 555, the wireless reference device 505 may then determine correction information based on a comparison of the estimate of north and displacement data received from the wireless mobile device 510 with the determined displacement of the wireless mobile device 510 with respect to the wireless reference device's knowledge of north. For example, the wireless mobile device 510 may indicate (in the evolving-alignment data communicated at arrow 550) that its direction of displacement is X degrees from its estimate of true north, whereas the wireless reference device 505 may determine that the direction of displacement of the wireless mobile device 510 is actually Y degrees from true north. The wireless reference device 505 may then determine that the wireless mobile device's estimate of true north is misaligned by the difference between X and Y degrees. This difference can be included in the correction information which is sent from the wireless reference device 505 to the wireless mobile device 510 as part of the study-state-alignment data, shown by arrow 560. The wireless mobile device 510 may use this correction information to update its estimate of north, as indicated by block 565. As indicated by arrow 570, the series of operations in block 530 may be repeated until a termination condition is detected, as shown by block 575. Finally, as indicated by arrow 580, the wireless mobile device 510 may send a request to end reference frame alignment assistance, which may be acknowledged by the wireless reference device 505, as indicated by arrow 585.

As previously indicated, some conditions may allow a handoff between a wireless reference device 505 and a second wireless reference device (not shown in FIG. 5). These conditions may include, for example, the wireless reference device 505 and/or wireless mobile device 510 detecting or anticipating a loss of an LOS condition between the wireless reference device 505 and wireless mobile device 510 (which can prevent accurate ranging/angle measurements performed at block 535), and the wireless reference device 505 and/or wireless mobile device 510 further detecting an LOS condition between the wireless mobile device 510 and the second wireless reference device. In these conditions, the wireless mobile device 510 and/or wireless reference device 505 may communicate information regarding the second wireless reference device to the other. In the process 500, this communication can occur subsequent to the detection of the termination condition at block 575 but prior to the termination of alignment assistance at block 585, for example. Additionally, according to some embodiments, the wireless reference device 505 and/or wireless mobile device 510 may communicate the evolving-alignment data and/or steady-state-alignment data to the second wireless reference device as part of the handoff process, and the second wireless device can use that information in performing, with the wireless mobile device 510, a subsequent iteration of the operations in block 530. Thus, the handoff can effectively take place between iterations, allowing a second wireless reference device to pick up the process 500 where the wireless reference device 505 left off.

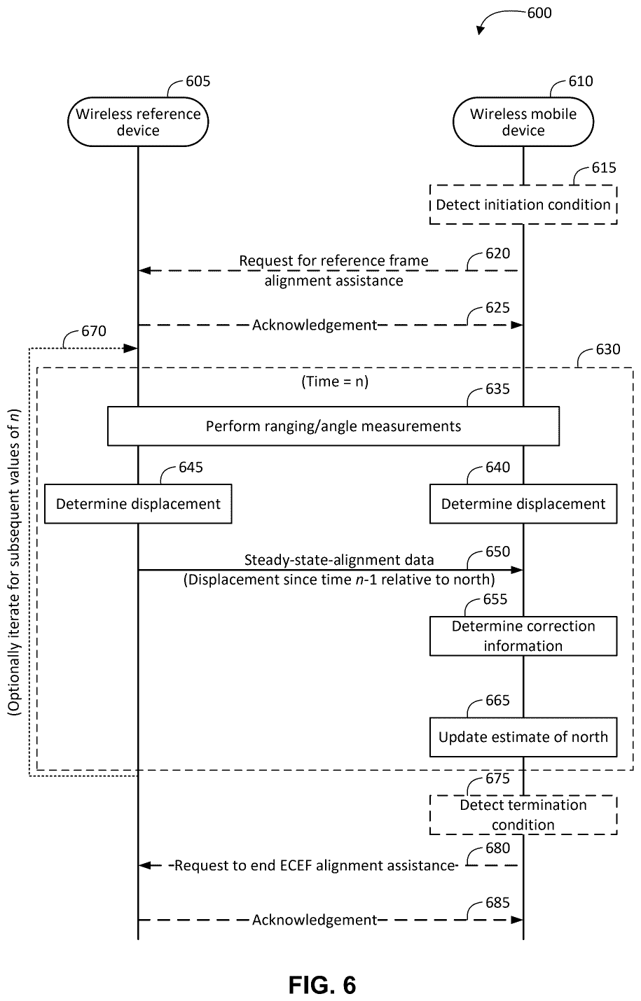

FIG. 6 is a message flow diagram of another example process 600 by which a wireless reference device 605 may provide a wireless mobile device 610 with alignment assistance. As shown, this process 600 is similar to the process 500 in FIG. 5. Moreover, operations 615-685 may be performed in a manner similar to corresponding operations 515-585 in the process 500, as described above. Here, however, certain operations in the iterative processes encompassed by block 630 are different. In particular, the wireless reference device 605 may provide its determination of the wireless mobile device's direction of displacement since a previous time (e.g., n−1), relative to north, as indicated by arrow 650. The wireless reference device 605 may also include its own displacement (if any) since the previous time. This information allows the wireless mobile device 610 to determine its own correction information, as indicated at block 655, which it may then use to update its estimate of north, as indicated at block 665. Thus, the process 500 in FIG. 5 provides for the wireless reference device 505 determining the correction information (at block 555), whereas the process 600 of FIG. 6 provides for the wireless mobile device 610 determining the correction information (at block 655). The determination of which process to use between process 500 and process 600 may be based on various considerations, including, for example, processing capability of the devices involved, available bandwidth, or the like.

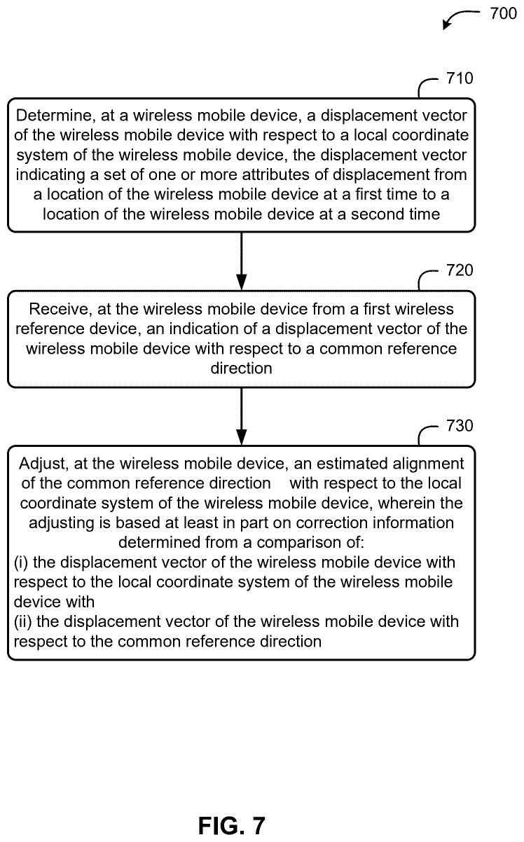

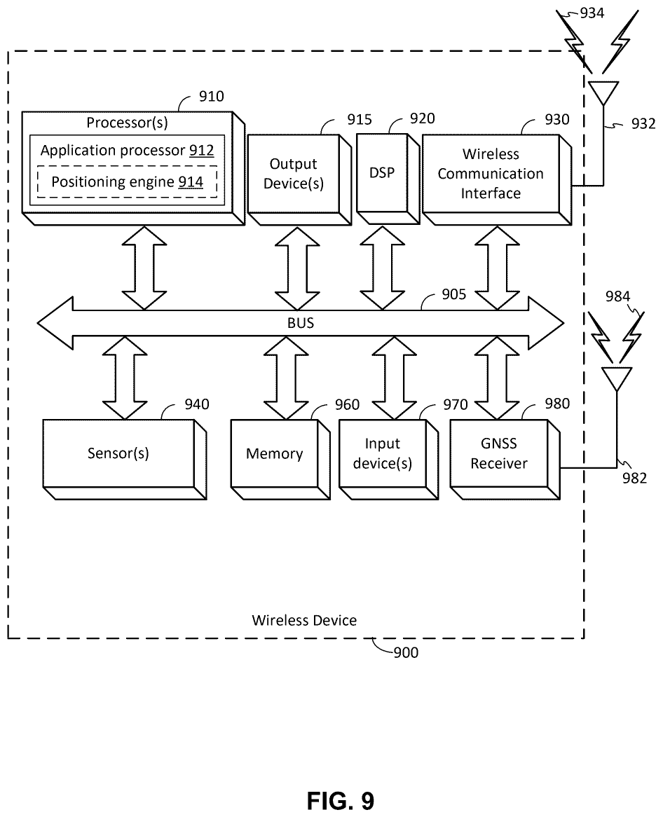

FIG. 7 is a flow diagram of a method 700 of coordinating a frame of reference between wireless devices, according to an embodiment. Aspects of the method 700 reflect the functionality of a mobile device (e.g., a wireless mobile device) as described in the embodiments above. As such, means and/or structure for performing the functionality illustrated in one or more of the blocks shown in FIG. 7 may be performed by hardware and/or software components of a wireless device. Example components of a wireless device are illustrated in FIG. 9, which is described in more detail below.

At block 710, the functionality comprises determining, at a wireless mobile device, a displacement vector of the wireless mobile device with respect to a local coordinate system of the wireless mobile device, the displacement vector indicating a set of one or more attributes of displacement from a location of the wireless mobile device at a first time to a location of the wireless mobile device at a second time. This functionality may correspond, for example, to block 540 in FIG. 5 and/or block 640 of FIG. 6, described above. As noted herein, a direction of the displacement may be one attribute of displacement. However, alternative embodiments may have additional or alternative attributes. According to some embodiments, the set of one or more attributes of displacement may comprise a direction of the displacement, a function of the direction of the displacement, a magnitude of the displacement, function of the magnitude of the displacement, or any combination thereof.

Means for performing functionality at block 710 may comprise one or more processors 910, a DSP 920, a wireless communication interface 930, one or more sensors 940, at least one memory 960, and/or other components of a wireless device 900, as illustrated in FIG. 9, described below.

At block 720, the functionality comprises receiving, at the wireless mobile device from a first wireless reference device, an indication of a displacement vector of the wireless mobile device with respect to a common reference direction. This functionality may correspond with arrows 560 of FIG. 5 and/or arrow 650 of FIG. 6, for example. Some embodiments may further include, prior to receiving the indication of the displacement vector of the wireless mobile device with respect to the common reference direction, sending, from the wireless mobile device to the first wireless reference device: an indication of the displacement vector of the wireless mobile device with respect to the local coordinate system of the wireless mobile device, an indication of the estimated alignment of the common reference direction with respect to the local coordinate system of the wireless mobile device, or both. In such embodiments, the received indication of the displacement vector of the wireless mobile device with respect to the common reference direction may comprise the correction information. An example of this functionality is shown in FIG. 5 and described above. The functionality prior to receiving the indication of the displacement vector may correspond, for example, to arrow 550 of FIG. 5.

Some embodiments may comprise determining, at the wireless mobile device, the correction information. This functionality may correspond with the functionality illustrated in FIG. 6, for example. In such embodiments, determining the displacement vector of the wireless mobile device with respect to the local coordinate frame of the wireless mobile device may comprise performing one or more positioning measurements with the wireless mobile device to determine a location estimate of the wireless mobile device at the second time, the one or more positioning measurements based on exchanging radio frequency radio frequency (RF) signals between the wireless mobile device and the first wireless reference device, or performing one or more inertial-measurement unit (IMU) measurements to determine a displacement estimate of the wireless mobile device at the second time, the displacement vector based at least in part on the displacement estimate. Additionally or alternatively, the displacement vector may be determined based on RF measurements of environmental features, such as a landmark. For example, relative position with respect to a landmark (or other static object in the environment) may be determined using RF sensing for AOA/ranging measurements with a wireless device located on or at the landmark, at both the first time and the second time. According to some embodiments, one or more positioning measurements comprise an angle of arrival (AOA) measurement, an angle of departure (AOD) measurement, a ranging measurement, or any combination thereof.

As noted in the embodiments herein, embodiments may also employ one or more additional features. For example, the reference device may move between the first time and the second time. As such, according to some embodiments, the determination of the correction information further accounts for a change in a location of the first wireless reference device at the first time to a location of the first wireless reference device at the second time. Some embodiments may include, prior to receiving the indication of the displacement vector of the wireless mobile device with respect to the common reference direction, sending, from the wireless mobile device to the first wireless reference device, a request to determine an alignment of the local coordinate system of the wireless mobile device to the common reference direction. This functionality may correspond, for example, to arrow 520 of FIG. 5 and/or arrow 620 of FIG. 6.

Means for performing functionality at block 720 may comprise one or more processors 910, a DSP 920, a wireless communication interface 930, at least one memory 960, and/or other components of a wireless device 900, as illustrated in FIG. 9, described below.

At block 730, the functionality comprises adjusting, at the wireless mobile device, an estimated alignment of the common reference direction with respect to the local coordinate system of the wireless mobile device, wherein the adjusting is based at least in part on correction information determined from a comparison of: (i) the displacement vector of the wireless mobile device with respect to the local coordinate system of the wireless mobile device with (ii) the displacement vector of the wireless mobile device with respect to the common reference direction. This functionality may correspond with the functionality at block 565 of FIG. 5, and/or block 665 of FIG. 6, for example. As noted herein, a reference direction may comprise true north or may be defined within a common coordinate system (e.g., an access within a common coordinate system). As such, according to some embodiments, the estimated alignment of the common reference direction with respect to the local coordinate system of the wireless mobile device may comprise an estimated alignment of true north with respect to the local coordinate system of the wireless mobile, or an estimated alignment of one or more coordinate system attributes of a common reference coordinate system with respect to the local coordinate system of the wireless mobile, the one or more coordinate system attributes comprising an origin, an orientation of one or more axes, or both.

Means for performing functionality at block 730 may comprise one or more processors 910, a DSP 920, a wireless communication interface 930, one or more sensors 940, at least one memory 960, and/or other components of a wireless device 900, as illustrated in FIG. 9, described below.

Some embodiments may include additional features. For example, as illustrated in both FIGS. 5 and 6, aspects of the process may iterate for subsequent times. Accordingly, some embodiments may further comprise determining, at the wireless mobile device, a second displacement vector of the wireless mobile device with respect to the local coordinate system of the wireless mobile device, the second displacement vector indicating a second set of one or more attributes of displacement from the location of the wireless mobile device at the second time to a location of the wireless mobile device at a third time. These embodiments may further comprise receiving, at the wireless mobile device, an indication of the second displacement vector of the wireless mobile device with respect to the common reference direction, and further adjusting, at the wireless mobile device, the estimated alignment of the common reference direction with respect to the local coordinate system of the wireless mobile device, wherein the adjusting is based at least in part on second correction information determined from a comparison of: (i) the second displacement vector of the wireless mobile device with respect to the local coordinate system of the wireless mobile device with (ii) the second displacement vector of the wireless mobile device with respect to the common reference direction. As noted herein, according to some embodiments, a handoff may be performed between wireless reference devices, which may occur between iterations in which the estimated alignment is updated. For example, according to some embodiments, the indication of the second displacement vector of the wireless mobile device with respect to the common reference direction is received from a second wireless reference device. In such embodiments, the method may further comprise prior to receiving the indication of the second displacement vector of the wireless mobile device with respect to the common reference direction, sending, from the wireless mobile device to the second wireless reference device: an indication of the second displacement vector of the wireless mobile device with respect to the local coordinate system of the wireless mobile device, an indication of the adjusted estimated alignment of the common reference direction with respect to the local coordinate system of the wireless mobile device, or both. In such embodiments, the received indication of the second displacement vector of the wireless mobile device with respect to the common reference direction may comprise the second correction information. Handoffs between reference devices in this manner may be made based on a set of criteria that trigger the handoff. As noted elsewhere herein, this can be based on a determination of whether an LOS RF connection exists between the reference device and mobile device, whether there is an expected loss of LOS, or the like. For example, according to some embodiments, communications between the wireless mobile device and the second wireless reference device are based at least in part on a loss or anticipated loss of a line-of-sight (LOS) RF connection between the wireless mobile device and the first wireless reference device.

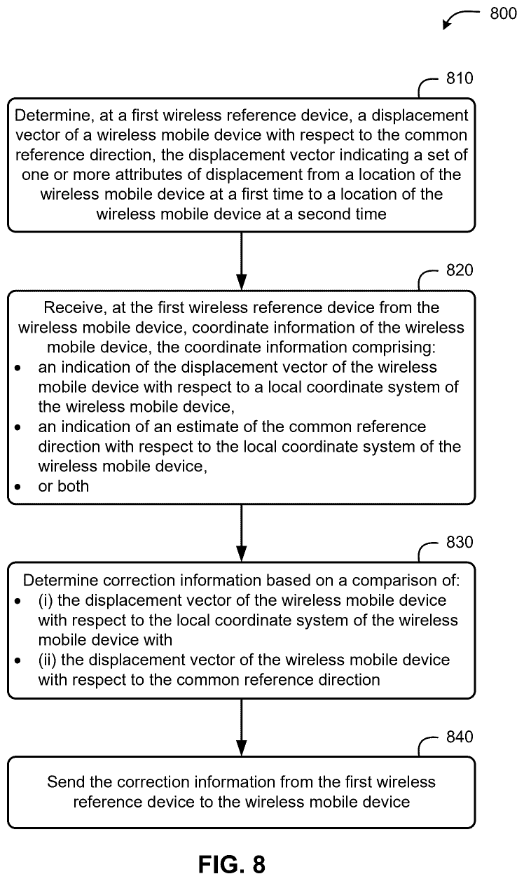

FIG. 8 is a flow diagram of a method 800 of determining an alignment of a common reference direction to a local coordinate system of a wireless mobile device, according to an embodiment. Aspects of the method 800 reflect the functionality of a reference device (e.g., a wireless reference device) as described in the embodiments above. As such, means and/or structure for performing the functionality illustrated in one or more of the blocks shown in FIG. 8 may be performed by hardware and/or software components of a wireless device. Example components of a wireless device are illustrated in FIG. 9, which is described in more detail below.

At block 810, the functionality comprises determining, at a first wireless reference device, a displacement vector of a wireless mobile device with respect to the common reference direction, the displacement vector indicating a set of one or more attributes of displacement from a location of the wireless mobile device at a first time to a location of the wireless mobile device at a second time. This functionality may correspond to, for example, block 545 of FIG. 5. According to some embodiments, determining the displacement vector of the wireless mobile device with respect to the common reference direction may comprise performing one or more positioning measurements with the first wireless reference device to determine a location estimate of the wireless mobile device at the second time, the one or more positioning measurements based on exchanging radio frequency radio frequency (RF) signals between the wireless mobile device and the first wireless reference device. In such embodiments, the one or more positioning measurements may comprise an angle of arrival (AOA) measurement, an angle of departure (AOD) measurement, a ranging measurement, or any combination thereof.

Means for performing functionality at block 810 may comprise one or more processors 910, a DSP 920, a wireless communication interface 930, one or more sensors 940, at least one memory 960, a GNSS receiver 980, and/or other components of a wireless device 900, as illustrated in FIG. 9, described below.

At block 820, the functionality comprises receiving, at the first wireless reference device from the wireless mobile device, coordinate information of the wireless mobile device, the coordinate information comprising: an indication of the displacement vector of the wireless mobile device with respect to a local coordinate system of the wireless mobile device, an indication of an estimate of the common reference direction with respect to the local coordinate system of the wireless mobile device, or both. This functionality may correspond to, for example, arrow 550 of FIG. 5, described above.

Means for performing functionality at block 820 may comprise one or more processors 910, a DSP 920, a wireless communication interface 930, at least one memory 960, and/or other components of a wireless device 900, as illustrated in FIG. 9, described below.

At block 830, the functionality comprises determining correction information based on a comparison of: (i) the displacement vector of the wireless mobile device with respect to the local coordinate system of the wireless mobile device with (ii) the displacement vector of the wireless mobile device with respect to the common reference direction. This functionality may correspond to, for example, block 555 of FIG. 5, described above. According to some embodiments, determining the correction information may further comprise accounting for a change in a location of the first wireless reference device at the first time to a location of the first wireless reference device at the second time.

Means for performing functionality at block 830 may comprise one or more processors 910, a DSP 920, a wireless communication interface 930, one or more sensors 940, at least one memory 960, a GNSS receiver 980, and/or other components of a wireless device 900, as illustrated in FIG. 9, described below.

At block 840, the functionality comprises sending the correction information from the first wireless reference device to the wireless mobile device. This functionality may correspond to arrow 560 of FIG. 5, for example. Means for performing functionality at block 840 may comprise one or more processors 910, a DSP 920, a wireless communication interface 930, at least one memory 960, and/or other components of a wireless device 900, as illustrated in FIG. 9, described below.

As noted, embodiments may include one or more additional features, depending on desired functionality. For example, some embodiments may further comprise, prior to determining the displacement vector of the wireless mobile device with respect to the common reference direction, receiving, at the first wireless reference device from the wireless mobile device, a request to determine an alignment of the local coordinate system of the wireless mobile device to the common reference direction. According to some embodiments, the wireless mobile device, the first wireless reference device, or both, comprise a respective user equipment (UE) of a wireless communication network. Some embodiments may further comprise determining, at the first wireless reference device, a second displacement vector of the wireless mobile device with respect to the common reference direction, the second displacement vector indicating a direction from the location of the wireless mobile device at the first time to a location of the wireless mobile device at a third time; receiving, at the first wireless reference device from the wireless mobile device, second coordinate information of the wireless mobile device, the second coordinate information comprising: an indication of the second displacement vector of the wireless mobile device with respect to the local coordinate system of the wireless mobile device, an indication of an updated estimated alignment of the common reference direction with respect to the local coordinate system of the wireless mobile device, or both; and determining second correction information based on a comparison of: (i) the second displacement vector of the wireless mobile device with respect to the local coordinate system of the wireless mobile device with (ii) the second displacement vector of the wireless mobile device with respect to the common reference direction; and sending the second correction information from the first wireless reference device to the wireless mobile device. Such embodiments may further comprise sending the correction information from the first wireless reference device to a second wireless reference device. As mentioned previously, a handover process may be triggered by one or more criteria. According to some embodiments, such criteria may include the event of loss, or anticipated loss, of LOS to the wireless mobile device.

FIG. 9 is a block diagram of an embodiment of a wireless device 900, which can be utilized as described herein above (e.g., in association with FIGS. 1-8. For example, the wireless device 900 can correspond to mobile device 105 of FIG. 1, GNSS receiver 210 of FIG. 2, mobile device 320 and/or reference device 310 of FIGS. 3A-3D, mobile device 420 and/or reference device 410 of FIGS. 4A-4D, wireless reference device 505 and/or wireless mobile device 510 of FIG. 5, and/or wireless reference device 605 and/or wireless mobile device 610 of FIG. 6. It should be noted that FIG. 9 is meant only to provide a generalized illustration of various components, any or all of which may be utilized as appropriate. In other words, because mobile devices can vary widely in functionality, they may include only a portion of the components shown in FIG. 9. It can be noted that, in some instances, components illustrated by FIG. 9 can be localized to a single physical device and/or distributed among various networked devices, which may be disposed at different physical locations.

The wireless device 900 is shown comprising hardware elements that can be electrically coupled via a bus 905 (or may otherwise be in communication, as appropriate). The hardware elements may include a processor(s) 910, which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. Processor(s) 910 may further comprise an application processor 912, as described in the embodiments above, which may execute a positioning engine 914. As noted, the positioning engine 914 may use a GNSS position fix from the GNSS receiver 980 and/or information from other positioning sources (e.g., sensors 940) to determine a location of the wireless device 900. As shown in FIG. 9, some embodiments may have a separate DSP 920, depending on desired functionality. Location determination and/or other determinations based on wireless communication may be provided in the processor(s) 910 and/or wireless communication interface 930 (discussed below). The wireless device 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The wireless device 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX™ device, a WAN device, and/or various cellular devices, etc.), and/or the like, which may enable the wireless device 900 to communicate with other devices as described in the embodiments above. The wireless communication interface 930 may permit data and signaling to be communicated (e.g., transmitted and received) with, for example, base stations, access points, and/or other access node types, and/or other network components, computer systems, and/or any other electronic devices communicatively coupled a wireless communication network. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations and other terrestrial transceivers, such as wireless devices and access points. The wireless device 900 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The wireless device 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used as positioning data sources and/or to obtain other position-related measurements and/or other information.

Embodiments of the wireless device 900 may also include a GNSS receiver 980 capable of receiving signals 984 from one or more GNSS satellites via one or more GNSS bands using GNSS antenna(s) 982. The GNSS receiver 980 may therefore be used to provide GNSS position fixes based on received GNSS signals 984. The GNSS receiver 980 may be capable of processing signals received via many GNSS bands/constellations. In some embodiments, the GNSS receiver 980 may include front-end analog components for each GNSS band (or for pairs of GNSS bands having similar baseband frequencies), and may share digital circuitry among multiple GNSS bands. Additionally or alternatively, digital circuitry may be separate for each GNSS band. The GNSS receiver 980 may communicate with other components of the wireless device 900 (e.g., processor(s) 910, including application processor 912 and/or positioning engine 914) via a data interface with the bus 905.

The GNSS receiver 980 can extract a position of the wireless device 900, using conventional techniques, from GNSS satellites 110 of a GNSS system, such as GPS, Galileo, GLONASS, Quasi-Zenith Satellite System (QZSS) over Japan, IRNSS over India, BeiDou Navigation Satellite System (BDS), and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein a GNSS may include any combination of one or more global and/or regional navigation satellite systems and/or augmentation systems, and GNSS signals may include GNSS, GNSS-like, and/or other signals associated with such one or more GNSS.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a GNSS positioning engine, which can use GNSS measurements from the measurement engine to determine a position of the GNSS receiver (e.g., a position fix) using an Extended Kalman Filter (EKF), Weighted Least Squares (WLS), a hatch filter, particle filter, or the like. The GNSS positioning engine may also be executed as part of a larger processing engine e.g., positioning engine 914 executed by application processor 912.

The wireless device 900 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the wireless device 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the functionality discussed above may be implemented as code and/or instructions executable by the wireless device 900 (e.g., using processor(s) 910). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.
Clause 1: A method of determining an alignment of a common reference direction to a local coordinate system of a wireless mobile device, the method comprising: determining, at a first wireless reference device, a displacement vector of a wireless mobile device with respect to the common reference direction, the displacement vector indicating a set of one or more attributes of displacement from a location of the wireless mobile device at a first time to a location of the wireless mobile device at a second time; receiving, at the first wireless reference device from the wireless mobile device, coordinate information of the wireless mobile device, the coordinate information comprising: an indication of the displacement vector of the wireless mobile device with respect to a local coordinate system of the wireless mobile device, an indication of an estimate of the common reference direction with respect to the local coordinate system of the wireless mobile device, or both; determining correction information based on a comparison of: (i) the displacement vector of the wireless mobile device with respect to the local coordinate system of the wireless mobile device with (ii) the displacement vector of the wireless mobile device with respect to the common reference direction; and sending the correction information from the first wireless reference device to the wireless mobile device.
Clause 2: The method of clause 1, wherein determining the displacement vector of the wireless mobile device with respect to the common reference direction comprises performing one or more positioning measurements with the first wireless reference device to determine a location estimate of the wireless mobile device at the second time, the one or more positioning measurements based on exchanging radio frequency radio frequency (RF) signals between the wireless mobile device and the first wireless reference device.
Clause 3: The method of clause 2, wherein the one or more positioning measurements comprise: an angle of arrival (AOA) measurement, an angle of departure (AOD) measurement, a ranging measurement, or any combination thereof.
Clause 4: The method of any one of clauses 1-3, wherein determining the correction information further comprises accounting for a change in a location of the first wireless reference device at the first time to a location of the first wireless reference device at the second time.
Clause 5: The method of any one of clauses 1-4, further comprising, prior to determining the displacement vector of the wireless mobile device with respect to the common reference direction, receiving, at the first wireless reference device from the wireless mobile device, a request to determine an alignment of the local coordinate system of the wireless mobile device to the common reference direction.
Clause 6: The method of any one of clauses 1-5, wherein the wireless mobile device, the first wireless reference device, or both, comprise a respective user equipment (UE) of a wireless communication network.
Clause 7: The method of any one of clauses 1-6, further comprising: determining, at the first wireless reference device, a second displacement vector of the wireless mobile device with respect to the common reference direction, the second displacement vector indicating a direction from the location of the wireless mobile device at the first time to a location of the wireless mobile device at a third time; receiving, at the first wireless reference device from the wireless mobile device, second coordinate information of the wireless mobile device, the second coordinate information comprising: an indication of the second displacement vector of the wireless mobile device with respect to the local coordinate system of the wireless mobile device, an indication of an updated estimated alignment of the common reference direction with respect to the local coordinate system of the wireless mobile device, or both; and determining second correction information based on a comparison of: (i) the second displacement vector of the wireless mobile device with respect to the local coordinate system of the wireless mobile device with (ii) the second displacement vector of the wireless mobile device with respect to the common reference direction; and sending the second correction information from the first wireless reference device to the wireless mobile device.
Clause 8: The method of any one of clauses 1-7, further comprising, sending the correction information from the first wireless reference device to a second wireless reference device.
Clause 9: A device comprising one or more transceivers, one or more memories, and one or more processors communicatively coupled with the one or more transceivers and the one or more memories, the one or more processors configured to perform the method of any one of clauses 1-9.
Clause 10: An apparatus having means for performing the method of any one of clauses 1-8.
Clause 11: A non-transitory computer-readable medium storing instructions, the instructions comprising code for performing the method of any one of clauses 1-8.
Clause 12: A method of coordinating a frame of reference between wireless devices, the method comprising: determining, at a wireless mobile device, a displacement vector of the wireless mobile device with respect to a local coordinate system of the wireless mobile device, the displacement vector indicating a set of one or more attributes of displacement from a location of the wireless mobile device at a first time to a location of the wireless mobile device at a second time; receiving, at the wireless mobile device from a first wireless reference device, an indication of a displacement vector of the wireless mobile device with respect to a common reference direction; and adjusting, at the wireless mobile device, an estimated alignment of the common reference direction with respect to the local coordinate system of the wireless mobile device, wherein the adjusting is based at least in part on correction information determined from a comparison of: (i) the displacement vector of the wireless mobile device with respect to the local coordinate system of the wireless mobile device with (ii) the displacement vector of the wireless mobile device with respect to the common reference direction.
Clause 13: The method of clause 12, further comprising, prior to receiving the indication of the displacement vector of the wireless mobile device with respect to the common reference direction, sending, from the wireless mobile device to the first wireless reference device: an indication of the displacement vector of the wireless mobile device with respect to the local coordinate system of the wireless mobile device, an indication of the estimated alignment of the common reference direction with respect to the local coordinate system of the wireless mobile device, or both; and wherein the received indication of the displacement vector of the wireless mobile device with respect to the common reference direction comprises the correction information.
Clause 14: The method of clause 12, further comprising determining, at the wireless mobile device, the correction information.
Clause 15: The method of any one of clauses 12-14, wherein: determining the displacement vector of the wireless mobile device with respect to the local coordinate frame of the wireless mobile device comprises: performing one or more positioning measurements with the wireless mobile device to determine a location estimate of the wireless mobile device at the second time, the one or more positioning measurements based on exchanging radio frequency radio frequency (RF) signals between the wireless mobile device and the first wireless reference device; or performing one or more inertial-measurement unit (IMU) measurements to determine a displacement estimate of the wireless mobile device at the second time, the displacement vector based at least in part on the displacement estimate.
Clause 16: The method of clause 15, wherein the one or more positioning measurements comprise: an angle of arrival (AOA) measurement, an angle of departure (AOD) measurement, a ranging measurement, or any combination thereof.
Clause 17: The method of any one of clauses 12-16, wherein the determination of the correction information further accounts for a change in a location of the first wireless reference device at the first time to a location of the first wireless reference device at the second time.
Clause 18: The method of any one of clauses 12-17, further comprising, prior to receiving the indication of the displacement vector of the wireless mobile device with respect to the common reference direction, sending, from the wireless mobile device to the first wireless reference device, a request to determine an alignment of the local coordinate system of the wireless mobile device to the common reference direction.
Clause 19: The method of any one of clauses 12-18, further comprising: determining, at the wireless mobile device, a second displacement vector of the wireless mobile device with respect to the local coordinate system of the wireless mobile device, the second displacement vector indicating a second set of one or more attributes of displacement from the location of the wireless mobile device at the second time to a location of the wireless mobile device at a third time; receiving, at the wireless mobile device, an indication of the second displacement vector of the wireless mobile device with respect to the common reference direction; and further adjusting, at the wireless mobile device, the estimated alignment of the common reference direction with respect to the local coordinate system of the wireless mobile device, wherein the adjusting is based at least in part on second correction information determined from a comparison of: (i) the second displacement vector of the wireless mobile device with respect to the local coordinate system of the wireless mobile device with (ii) the second displacement vector of the wireless mobile device with respect to the common reference direction.
Clause 20: The method of clause 19, wherein the indication of the second displacement vector of the wireless mobile device with respect to the common reference direction is received from a second wireless reference device, the method further comprising: prior to receiving the indication of the second displacement vector of the wireless mobile device with respect to the common reference direction, sending, from the wireless mobile device to the second wireless reference device: an indication of the second displacement vector of the wireless mobile device with respect to the local coordinate system of the wireless mobile device, an indication of the adjusted estimated alignment of the common reference direction with respect to the local coordinate system of the wireless mobile device, or both; and wherein the received indication of the second displacement vector of the wireless mobile device with respect to the common reference direction comprises the second correction information.
Clause 21: The method of any one of clauses 19-20, wherein communications between the wireless mobile device and the second wireless reference device are based at least in part on a loss or anticipated loss of a line-of-sight (LOS) RF connection between the wireless mobile device and the first wireless reference device.
Clause 22: The method of any one of clauses 12-21, wherein the set of one or more attributes of displacement comprises: a direction of the displacement, a function of the direction of the displacement, a magnitude of the displacement, function of the magnitude of the displacement, or any combination thereof.
Clause 23: The method of any one of clauses 12-22, wherein the estimated alignment of the common reference direction with respect to the local coordinate system of the wireless mobile device comprises: an estimated alignment of true north with respect to the local coordinate system of the wireless mobile, or an estimated alignment of one or more coordinate system attributes of a common reference coordinate system with respect to the local coordinate system of the wireless mobile, the one or more coordinate system attributes comprising an origin, an orientation of one or more axes, or both.
Clause 24: A device comprising one or more transceivers, one or more memories, and one or more processors communicatively coupled with the one or more transceivers and the one or more memories, the one or more processors configured to perform the method of any one of clauses 12-23.
Clause 25: An apparatus having means for performing the method of any one of clauses 12-23.
Clause 26: A non-transitory computer-readable medium storing instructions, the instructions comprising code for performing the method of any one of clauses 12-23.

What is claimed is:

1. A method of coordinating a frame of reference between wireless devices, the method comprising:
determining, at a wireless mobile device, a displacement vector of the wireless mobile device with respect to a local coordinate system of the wireless mobile device, the displacement vector indicating a set of one or more attributes of displacement from a location of the wireless mobile device at a first time to a location of the wireless mobile device at a second time;
receiving, at the wireless mobile device from a first wireless reference device, an indication of a displacement vector of the wireless mobile device with respect to a common reference direction; and
adjusting, at the wireless mobile device, an estimated alignment of the common reference direction with respect to the local coordinate system of the wireless mobile device, wherein the adjusting is based at least in part on correction information determined from a comparison of:
(i) the displacement vector of the wireless mobile device with respect to the local coordinate system of the wireless mobile device with
(ii) the displacement vector of the wireless mobile device with respect to the common reference direction.

2. The method of claim 1, further comprising, prior to receiving the indication of the displacement vector of the wireless mobile device with respect to the common reference direction, sending, from the wireless mobile device to the first wireless reference device:
an indication of the displacement vector of the wireless mobile device with respect to the local coordinate system of the wireless mobile device,
an indication of the estimated alignment of the common reference direction with respect to the local coordinate system of the wireless mobile device, or
both; and
wherein the received indication of the displacement vector of the wireless mobile device with respect to the common reference direction comprises the correction information.

3. The method of claim 1, further comprising determining, at the wireless mobile device, the correction information.

4. The method of claim 1, wherein: determining the displacement vector of the wireless mobile device with respect to the local coordinate frame of the wireless mobile device comprises:
performing one or more positioning measurements with the wireless mobile device to determine a location estimate of the wireless mobile device at the second time, the one or more positioning measurements based on exchanging radio frequency radio frequency (RF) signals between the wireless mobile device and the first wireless reference device; or
performing one or more inertial-measurement unit (IMU) measurements to determine a displacement estimate of the wireless mobile device at the second time, the displacement vector based at least in part on the displacement estimate.

5. The method of claim 4, wherein the one or more positioning measurements comprise:
an angle of arrival (AOA) measurement,
an angle of departure (AOD) measurement,
a ranging measurement, or
any combination thereof.

6. The method of claim 1, wherein the determination of the correction information further accounts for a change in a location of the first wireless reference device at the first time to a location of the first wireless reference device at the second time.

7. The method of claim 1, further comprising, prior to receiving the indication of the displacement vector of the wireless mobile device with respect to the common reference direction, sending, from the wireless mobile device to the first wireless reference device, a request to determine an alignment of the local coordinate system of the wireless mobile device to the common reference direction.

8. The method of claim 1, wherein the wireless mobile device, the first wireless reference device, or both, comprise a respective user equipment (UE) of a wireless communication network.

9. The method of claim 1, further comprising:
determining, at the wireless mobile device, a second displacement vector of the wireless mobile device with respect to the local coordinate system of the wireless mobile device, the second displacement vector indicating a second set of one or more attributes of displacement from the location of the wireless mobile device at the second time to a location of the wireless mobile device at a third time;
receiving, at the wireless mobile device, an indication of the second displacement vector of the wireless mobile device with respect to the common reference direction; and
further adjusting, at the wireless mobile device, the estimated alignment of the common reference direction with respect to the local coordinate system of the wireless mobile device, wherein the adjusting is based at least in part on second correction information determined from a comparison of:
(i) the second displacement vector of the wireless mobile device with respect to the local coordinate system of the wireless mobile device with
(ii) the second displacement vector of the wireless mobile device with respect to the common reference direction.

10. The method of claim 9, wherein the indication of the second displacement vector of the wireless mobile device with respect to the common reference direction is received from a second wireless reference device, the method further comprising:
prior to receiving the indication of the second displacement vector of the wireless mobile device with respect to the common reference direction, sending, from the wireless mobile device to the second wireless reference device:
an indication of the second displacement vector of the wireless mobile device with respect to the local coordinate system of the wireless mobile device,
an indication of the adjusted estimated alignment of the common reference direction with respect to the local coordinate system of the wireless mobile device, or
both; and
wherein the received indication of the second displacement vector of the wireless mobile device with respect to the common reference direction comprises the second correction information.

11. The method of claim 10, wherein communications between the wireless mobile device and the second wireless reference device are based at least in part on a loss or anticipated loss of a line-of-sight (LOS) RF connection between the wireless mobile device and the first wireless reference device.

12. The method of claim 1, wherein the set of one or more attributes of displacement comprises:
a direction of the displacement,
a function of the direction of the displacement,
a magnitude of the displacement,
function of the magnitude of the displacement, or
any combination thereof.

13. The method of claim 1, wherein the estimated alignment of the common reference direction with respect to the local coordinate system of the wireless mobile device comprises:
an estimated alignment of true north with respect to the local coordinate system of the wireless mobile, or
an estimated alignment of one or more coordinate system attributes of a common reference coordinate system with respect to the local coordinate system of the wireless mobile, the one or more coordinate system attributes comprising an origin, an orientation of one or more axes, or both.

14. A wireless mobile device comprising:
at least one transceiver;
at least one memory; and
at least one processor communicatively coupled with the at least one transceiver and at least one memory, the at least one processor configured to:
determine a displacement vector of the wireless mobile device with respect to a local coordinate system of the wireless mobile device, the displacement vector indicating a set of one or more attributes of displacement from a location of the wireless mobile device at a first time to a location of the wireless mobile device at a second time;
receive, via the at least one transceiver from a first wireless reference device, an indication of a displacement vector of the wireless mobile device with respect to a common reference direction; and
adjust an estimated alignment of the common reference direction with respect to the local coordinate system of the wireless mobile device, wherein the adjusting is based at least in part on correction information determined from a comparison of:
(i) the displacement vector of the wireless mobile device with respect to the local coordinate system of the wireless mobile device with
(ii) the displacement vector of the wireless mobile device with respect to the common reference direction.

15. The wireless mobile device of claim 14, wherein the at least one processor is further configured to, prior to receiving the indication of the displacement vector of the wireless mobile device with respect to the common reference direction, send, via the at least one transceiver to the first wireless reference device:
an indication of the displacement vector of the wireless mobile device with respect to the local coordinate system of the wireless mobile device,
an indication of the estimated alignment of the common reference direction with respect to the local coordinate system of the wireless mobile device, or
both; and
wherein, to receive the indication of the displacement vector of the wireless mobile device with respect to the common reference direction, the at least one processor is configured to receive the correction information.

16. The wireless mobile device of claim 14, wherein the at least one processor is further configured to is further configured to determine the correction information.

17. The wireless mobile device of claim 14, wherein, to determine the displacement vector of the wireless mobile device with respect to the local coordinate frame of the wireless mobile device, the at least one processor is configured to:
perform one or more positioning measurements to determine a location estimate of the wireless mobile device at the second time, the one or more positioning measurements based on exchanging radio frequency radio frequency (RF) signals between the wireless mobile device and the first wireless reference device; or
perform one or more inertial-measurement unit (IMU) measurements to determine a displacement estimate of the wireless mobile device at the second time, the displacement vector based at least in part on the displacement estimate.

18. The wireless mobile device of claim 17, wherein the at least one processor, when performing the one or more positioning measurements, is configured to perform:
an angle of arrival (AOA) measurement,
an angle of departure (AOD) measurement,
a ranging measurement, or
any combination thereof.

19. The wireless mobile device of claim 14, wherein the wireless mobile device comprise a user equipment (UE) of a wireless communication network.

20. A device comprising:
means for determining a displacement vector of a wireless mobile device with respect to a local coordinate system of the wireless mobile device, the displacement vector indicating a set of one or more attributes of displacement from a location of the wireless mobile device at a first time to a location of the wireless mobile device at a second time;
means for receiving, from a first wireless reference device, an indication of a displacement vector of the wireless mobile device with respect to a common reference direction; and
means for adjusting an estimated alignment of the common reference direction with respect to the local coordinate system of the wireless mobile device, wherein the adjusting is based at least in part on correction information determined from a comparison of:
(i) the displacement vector of the wireless mobile device with respect to the local coordinate system of the wireless mobile device with
(ii) the displacement vector of the wireless mobile device with respect to the common reference direction.
